(19) United States
(12) Patent Application Publication
(10) Pub. No.: US 2025/0053986 A1
(43) Pub. Date: Feb. 13, 2025

(54) ALERTS FOR DATA TRANSACTIONS

(71) Applicant: Motorola Mobility LLC, Chicago, IL (US)

(72) Inventors: Krishnan Raghavan, Bangalore (IN); Vignesh Karthik Mohan, Bangalore (IN); Rahul Sahadevan, Bengaluru (IN)

(73) Assignee: Motorola Mobility LLC, Chicago, IL (US)

(21) Appl. No.: 18/233,124

(22) Filed: Aug. 11, 2023

(51) Int. Cl. G06Q 20/40

(52) U.S. Cl. CPC G06Q 20/4016; G06Q 20/4014

(57) ABSTRACT

Techniques for feedback alerts for data transactions are described and are implementable to enable users to provide transaction feedback for data transactions and to receive feedback alerts for data transactions. In implementations, a user can initiate a data transaction with a particular party and can be presented with a feedback alert describing transaction feedback for previous data transactions with the particular party.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without challenges. For instance, users can utilize finance applications to perform transactions that the users may later regret.

### BRIEF DESCRIPTION OF THE DRAWINGS

Aspects of alerts for data transactions are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of alerts for data transactions can be implemented.

FIGS. 2a, 2b depict aspects of an example system for feedback for data transactions in accordance with one or more implementations.

FIG. 3 depicts an example transaction feedback graphical user interface (GUI) in accordance with one or more implementations.

FIG. 4 depicts an example transaction GUI in accordance with one or more implementations.

FIG. 5 depicts the example transaction GUI in accordance with one or more implementations.

FIG. 6 depicts the example transaction GUI in accordance with one or more implementations.

FIG. 7 depicts the example transaction GUI 400 in accordance with one or more implementations.

FIG. 8 depict aspects of an example system for feedback for data transactions in accordance with one or more implementations.

FIG. 9 depict aspects of an example system for alerts for data transactions in accordance with one or more implementations.

FIG. 10 depicts an example scenario for alerts for data transactions in accordance with one or more implementations.

FIG. 11 depicts an example scenario for location alerts in accordance with one or more implementations.

FIG. 12 illustrates a flow chart depicting an example method for feedback for data transactions in accordance with one or more implementations.

FIG. 13 illustrates a flow chart depicting an example method for enabling updated transaction feedback in accordance with one or more implementations.

FIG. 14 illustrates a flow chart depicting an example method for feedback for data transactions in accordance with one or more implementations.

FIG. 15 illustrates a flow chart depicting an example method for feedback for data transactions in accordance with one or more implementations.

FIG. 16 illustrates a flow chart depicting an example method for feedback for data transactions in accordance with one or more implementations.

FIG. 17 illustrates a flow chart depicting an example method for alerts for data transactions in accordance with one or more implementations.

FIG. 18 illustrates a flow chart depicting an example method for alerts for data transactions in accordance with one or more implementations.

FIG. 19 illustrates a flow chart depicting an example method for alerts for data transactions in accordance with one or more implementations.

FIG. 20 illustrates a flow chart depicting an example method for alerts for data transactions in accordance with one or more implementations.

FIG. 21 illustrates various components of an example device in which aspects of feedback and alerts for data transactions can be implemented.

### DETAILED DESCRIPTION

Techniques for alerts for data transactions are described and are implementable to enable user feedback regarding data transactions (e.g., payment transactions) to be collected, aggregated, and provided to users. For instance, the described techniques enable a user to view information about data transactions and to provide transaction feedback for the data transactions. The transaction feedback can be aggregated and presented to the user. In implementations, transaction feedback indicates user sentiment regarding data transactions, such as whether the user views a data transaction with a positive sentiment (e.g., the data transaction was a good and/or great experience), a medium sentiment (e.g., the user has no strong feelings about the data transaction), or a negative sentiment, e.g., the data transaction was a poor experience.

Further, the described techniques enable various types of feedback alerts to be output based on various conditions, such as a user initiating a data transaction with a party (referred to herein as a “data recipient) with which the user previously engaged in a data transaction and provided transaction feedback. For instance, consider a scenario where a user visits a particular retail location, engages in a data transaction to purchase an item at the retail location, and has a poor experience as part of the data transaction. The user can provide negative transaction feedback regarding the data transaction at the retail location. If the user subsequently visits the retail location and initiates a further data transaction, a feedback alert can be provided to the user's device reminding the user of the previous poor experience. This can enable the user to make a more informed decision about whether to proceed with the further data transaction. In an additional or alternative implementation transaction feedback at different locations can be tracked and thus when a user's device is detected at a particular location (e.g., a retail location) a location alert can be presented that reminds the user of previous transaction feedback (e.g., positive and/or negative) regarding the particular location.

Accordingly, techniques described herein enable users to provide transaction feedback for data transactions and feedback alerts to be provided to remind the users of the transaction feedback. In implementations, a data transaction represents a payment transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling user feedback and feedback alerts for data transactions, the described techniques can conserve user and system resources (e.g., memory, processor bandwidth, network bandwidth, etc.) that may otherwise be used to perform undesirable data transactions, and thus the described techniques can improve the operation of computing devices and data networks.

While features and concepts of transaction feedback and feedback alerts for data transactions can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

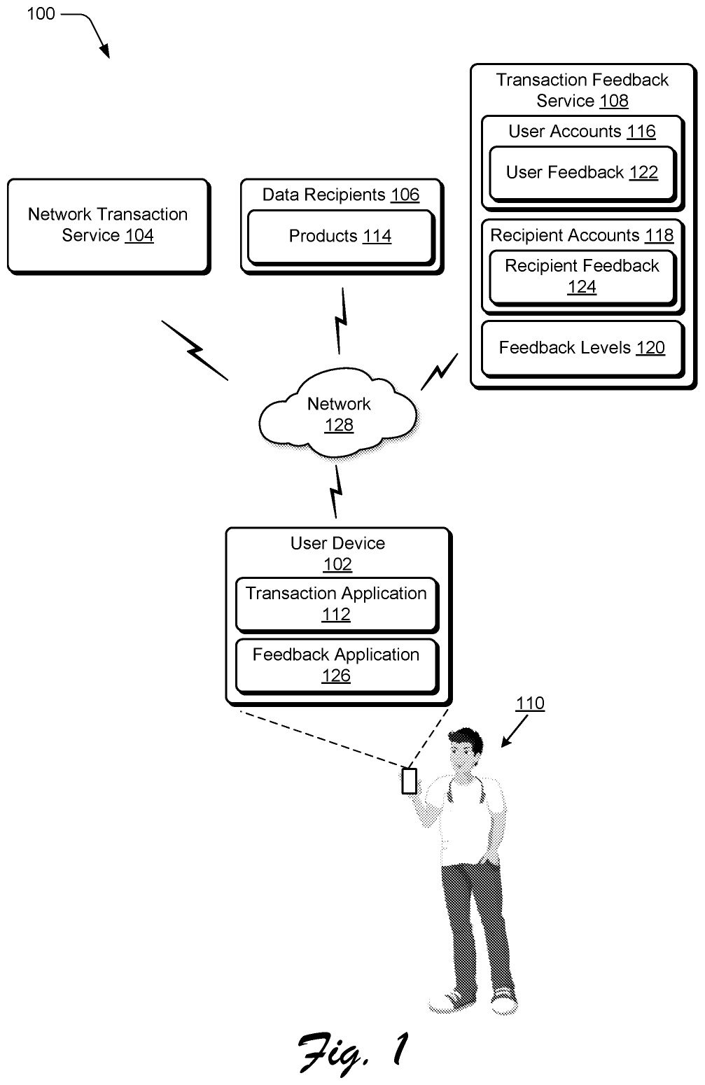

FIG. 1 illustrates an example environment 100 in which aspects of alerts for data transactions can be implemented. The environment 100 includes a user device 102, a network transaction service 104, data recipients 106, and a transaction feedback service 108. The user device 102 represents a device that can be used by a user 110 to perform and manage different data transactions, e.g., finance transactions such as purchasing goods and services. Examples of the user device 102 include mobile devices such as mobile phones, wearable devices, extended reality devices, tablets, laptops, etc.

The network transaction service 104 represents a network-based service that is accessible to the user device 102 to perform different data transactions. The network transaction service 104 can be implemented by various entities, such as a banking entity, a payment service, an enterprise entity, a trading entity, a data storage and/or management entity, and/or combinations thereof. The user 110, for instance, can utilize a transaction application 112 on the user device 102 to access the network transaction service 104 to perform different finance transactions, such as to transfer value amounts (e.g., monetary values) for different purposes, e.g., to purchase goods and services. The transaction application 112, for example, represents functionality that enables various finance-related transactions to be performed via the user device 102, including access to the network transaction service 104.

The data recipients 106 represents entities with which the user device 102 can engage in a data transaction. The user device 102, for instance, can initiate an exchange of data with the data recipients 106. For example, the data recipients 106 can provide products 114 (e.g., goods and/or services) to the user 110 and in exchange the user device 102 can cause a transfer of data (e.g., data representing an exchange of value) to the data recipients 106. In at least one implementation the data exchange between the user device 102 and the data recipients 106 is facilitated (e.g., managed) by the network transaction service 104. The network transaction service 104, for example, can implement a transfer of data (e.g., a data representation of value such as monetary value) to the data recipients 106 on behalf of the user device 102.

The transaction feedback service 108 represents a network-based service that can manage feedback regarding data transactions for various entities, such as the user device 102, the network transaction service 104, a data recipient 106, and so forth. For instance, when the user device 102 engages in a data transaction with a data recipient 106 (e.g., an exchange of value for a product 114 provided by the data recipient 106), the user 110 can utilize the user device 102 to provide feedback to the transaction feedback service 108 regarding the data transaction. The feedback, for instance, can include data that identifies how the user 110 “rates” the data transaction, e.g., as a positive transaction, a satisfactory transaction, a negative transaction, etc.

The transaction feedback service 108 includes various data and functionality for aspects of feedback and alerts for data transactions, including user accounts 116, recipient accounts 118, and feedback levels 120. The user accounts 116 represent information indicating user feedback 122 for different users. The user accounts 116, for instance, include a user account 116 for the user 110 of the user device 102. The user accounts 116 include user feedback 122 that represents user feedback (e.g., ratings) for different data transactions. Further, and as detailed throughout this disclosure, instances of the user feedback 122 can be associated with instances of the data recipients 106 and/or instances of the products 114.

The recipient accounts 118 represent information regarding user feedback for different data transactions with the data recipients 106. For example, for instances of the data recipients 106, the transaction feedback service 108 maintains a respective recipient account 118 that includes respective recipient feedback 124 regarding data transactions associated with each of the instances of the data recipients 106. Further, instances of recipient feedback 124 can be associated with instances of user accounts 116 and instances of the products 114. While the transaction feedback service 108 is illustrated as a separate entity than the network transaction service 104, in at least one implementation the transaction feedback service 108 can be implemented and/or managed by the network transaction service 104.

The feedback levels 120 represent different data categorizations of data transactions, such as implemented between the user device 102 and the data recipients 106. The feedback levels 120, for example, include different predefined selectable categorizations that indicate a relative user feedback regarding instances of data transactions. In an example implementation the feedback levels 120 can be based on a scale of 1-10 with 1 indicating an extreme user dissatisfaction with a data transaction and 10 indicating an extreme user satisfaction with a data transaction. The user device 102 includes a feedback application 126 which can enable the user 110 to interact with the user device 102 to provide feedback regarding data transactions. The feedback application 126, for instance, represents a portal to the transaction feedback service 108 that enables the user device 102 to communicate user feedback 122 to a user account 116 associated with the user device 102 and/or the user 110.

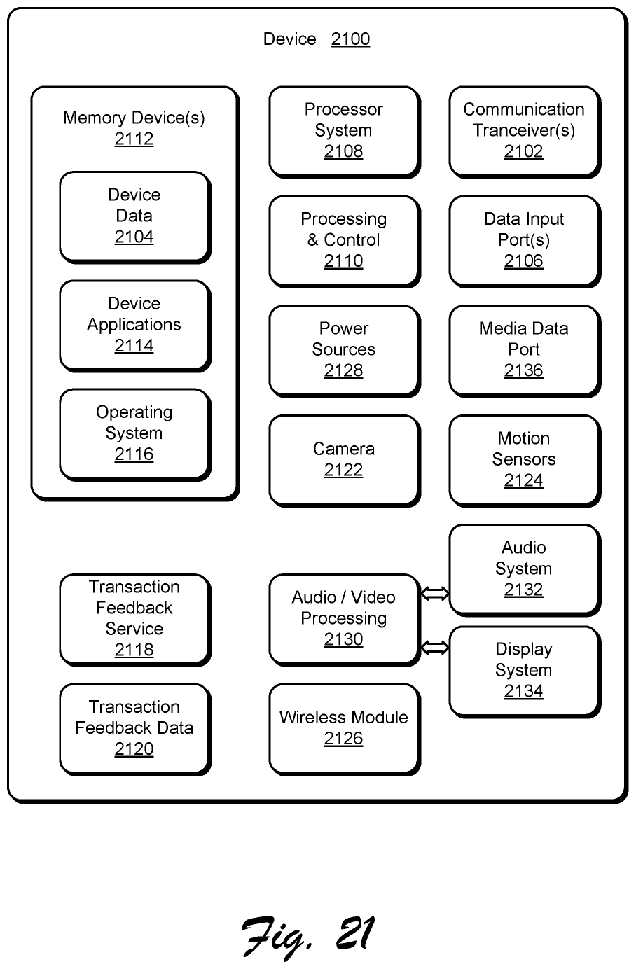

The user device 102, the network transaction service 104, the transaction feedback service 108, and/or the data recipients 106 can be implemented in various ways and include various functionality, examples of which are discussed below with reference to the example device 2100 of FIG. 21. Further, various entities of the environment 100 can be connected and communicate via a network 128. The network 128, for example, can represent a combination of wired and wireless networks via which the user device 102, the network transaction service 104, the transaction feedback service 108, and/or the data recipients 106 can participate in various types of communication, such as wired and/or wireless data communication.

Having discussed an example environment in which the disclosed techniques can be performed, consider now some example scenarios and implementation details for implementing the disclosed techniques.

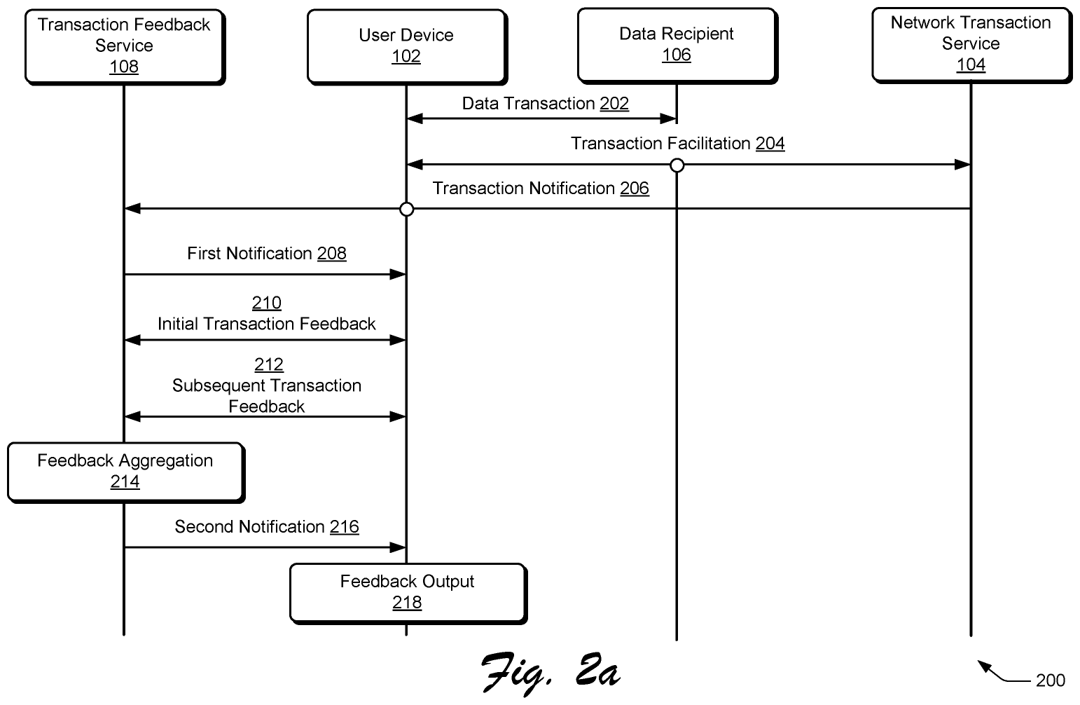

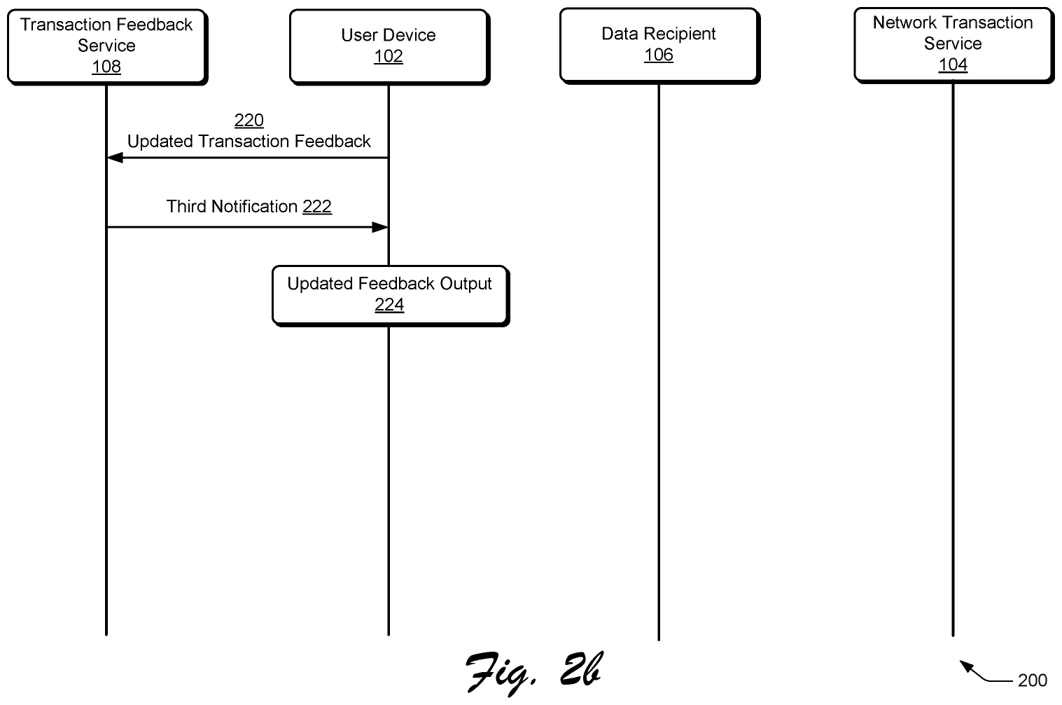

FIGS. 2a, 2b depict aspects of an example system 200 for feedback for data transactions in accordance with one or more implementations. The system 200 can be implemented in the environment 100 and incorporates attributes of the environment 100 introduced above. In the system 200, the user device 102 engages in a data transaction 202 with a data recipient 106. The data transaction 202 can represent various types of data-based transactions, such as an exchange of data, a finance transaction (e.g., an exchange of value for goods and/or services), and combinations thereof. In at least one implementation the data transaction 202 involves a provision of goods and/or services by the data recipient 106 to the user device 102. The user device 102, the data recipient 106, and the network transaction service 104 participate in a transaction facilitation 204 which involves a transfer of data (e.g., data representing value) from the network transaction service 104 to the data recipient 106. For example, in the context of a finance transaction and as part of the transaction facilitation 204, the network transaction service 104 transfers a data representation of value (e.g., monetary value, digital currency, etc.) on behalf of the user device 102 to the data recipient 106.

Further to the system 200 a transaction notification 206 pertaining to the data transaction 202 is communicated to the transaction feedback service 108. The transaction notification 206 can include various information about the data transaction 202, such as an identifier of a user account 116 associated with the data transaction 202, an identifier of the user device 102, an identifier of the data recipient 106, an identifier of the network transaction service 104, a date and time at which the data transaction 202 is initiated and/or completed, a transaction type of the data transaction (e.g., a finance transaction, a data transfer transaction, etc.), and so forth. In the context of a finance transaction, the transaction notification 206 can include a value amount of the data transaction 202.

The transaction feedback service 108 can communicate a first notification 208 to the user device 102 that enables the user 110 to provide user feedback pertaining to the data transaction 202 via the user device 102. The first notification 208 can include various information pertaining to the data transaction 202, such as information described above with reference to the transaction notification 206. Further, the first notification 208 can include feedback indicia that are selectable to enable user feedback to be provided regarding the data transaction 202. The first notification 208 can be communicated to the user device 102 at various times related to the data transaction 202, such as within a threshold time period after completion of the data transaction 202, after the threshold time period after completion of the data transaction 202, etc.

Further to the system 200 the user 110 can interact with the user device 102 to provide transaction feedback regarding the data transaction 202 to the transaction feedback service 108. For instance, the user device 102 can communicate initial transaction feedback 210 regarding the data transaction 202 to the transaction feedback service 108. The initial transaction feedback 210, for example, represents transaction feedback that is provided via the user device 102 within a threshold time period from the data transaction 202. For instance, the initial transaction feedback 210 can be provided while the data transaction 202 and/or the transaction facilitation 204 are in progress (e.g., still pending), and/or the initial transaction feedback 210 can be provided within a threshold period of time such as within t minutes after conclusion of the data transaction 202 and/or the transaction facilitation 204.

Alternatively or additionally to the initial transaction feedback 210, the user device 102 can communicate subsequent transaction feedback 212 regarding the data transaction 202 to the transaction feedback service 108. The subsequent transaction feedback 212, for example, represents transaction feedback provided via the user device 102 after a threshold time period from the data transaction 202. For instance, the subsequent transaction feedback 212 can be provided after a threshold period of time such as after t minutes after conclusion of the data transaction 202 and/or the transaction facilitation 204.

Further to the system 200 the transaction feedback service 108 performs feedback aggregation 214 to aggregate transaction feedback including the initial transaction feedback 210 and/or the subsequent transaction feedback 212. The feedback aggregation 214, for instance, involves aggregating transaction feedback for multiple different data transactions involving the user device 102 and/or involving multiple different user devices and multiple different users. In implementations the feedback aggregation 214 can include sorting transaction feedback into different categories, such as based on data transaction type, data recipient 106 identity, user specified data transaction categories, etc.

The transaction feedback service 108 can then send a second notification 216 that includes transaction feedback to different users including the user device 102. The second notification, for instance, can identify different data recipients 106, data transactions performed with the data recipients 106, and transaction feedback regarding the data transactions. The user device 102 can perform feedback output 218 to output instances of transaction feedback such as received as part of the second notification 216. The feedback output 218, for instance, presents visual and/or audible representations of transaction feedback provided by the user 110 to the user device 102 and regarding previous data transactions, such as the data transaction 202.

FIG. 2b depicts further aspects of the system 200 for enabling updates to transaction feedback. For instance, after aggregated feedback is communicated from the transaction feedback service 108 to the user device 102 and output by the user device 102 as described above, the user 110 can provide updated transaction feedback 220 to the transaction feedback service 108. The updated transaction feedback 220, for example, can modify (e.g., change) transaction feedback for a particular data transaction and/or set of data transactions. The transaction feedback service 108 can then communicate a third notification 222 to the user device 102 that reflects the updated transaction feedback 220. Based on the third notification 222, the user device 102 can output updated feedback output 224, such as to update previously provided transaction feedback.

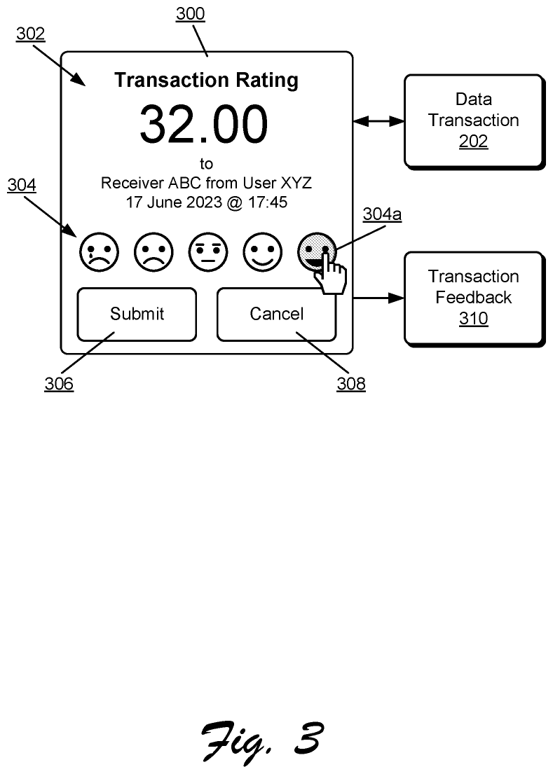

FIG. 3 depicts an example transaction feedback graphical user interface (GUI) 300 in accordance with one or more implementations. The transaction feedback GUI 300, for instance, is presented via the user device 102 and enables a user to view information about the data transaction 202 and to provide transaction feedback regarding the data transaction 202.

According to implementations the transaction feedback GUI 300 may be generated and/or managed by the transaction feedback service 108, the feedback application 126, and/or cooperatively between the transaction feedback service 108 and the feedback application 126. Further, the transaction feedback GUI 300 may be presented after completion of the data transaction 202, such as within a threshold time period after completion of the data transaction 202 and/or after the threshold time period after completion of the data transaction 202.

The transaction feedback GUI 300 includes a transaction information field 302, feedback indicia 304, a submit control 306, and a cancel control 308. The transaction information field 302 includes various information about the data transaction 202. For instance, in the context of a finance transaction, the transaction information field 302 identifies a value amount of the data transaction 202.

Further, the transaction information field 302 identifies a receiver entity of the data transaction 202 (e.g., a data recipient 106), a transferring entity for the data transaction 202 (e.g., the user 110 and/or a user account associated with the user 110), a date and time at which the data transaction 202 is initiated and/or completed, and so forth.

The feedback indicia 304 includes different feedback indicia that are selectable to provide transaction feedback regarding the data transaction 202. For instance, each of the feedback indicia 304 represents a respective feedback value, e.g., based on a defined feedback value scale. In at least one implementation feedback values correspond to a different indications of user sentiment regarding the data transaction 202. In this particular example the user 110 selects a feedback indicia 304a, which represents a high feedback value (e.g., high user sentiment such as high user satisfaction) regarding the data transaction 202.

The submit control 306 is selectable to cause transaction feedback input to the transaction feedback GUI 300 to be submitted (e.g., to the transaction feedback service 108) and the cancel control 308 is selectable to cause the transaction feedback GUI 300 to be removed, e.g., canceled. For instance, the user 110 selects the feedback indicia 304a and the submit control 306, which can cause transaction feedback 310 (e.g., the initial transaction feedback 210 and/or the subsequent transaction feedback 212) to be communicated to the transaction feedback service 108 and associated with the data transaction 202. The transaction feedback 310, for instance, includes a feedback value represented by the feedback indicia 304a.

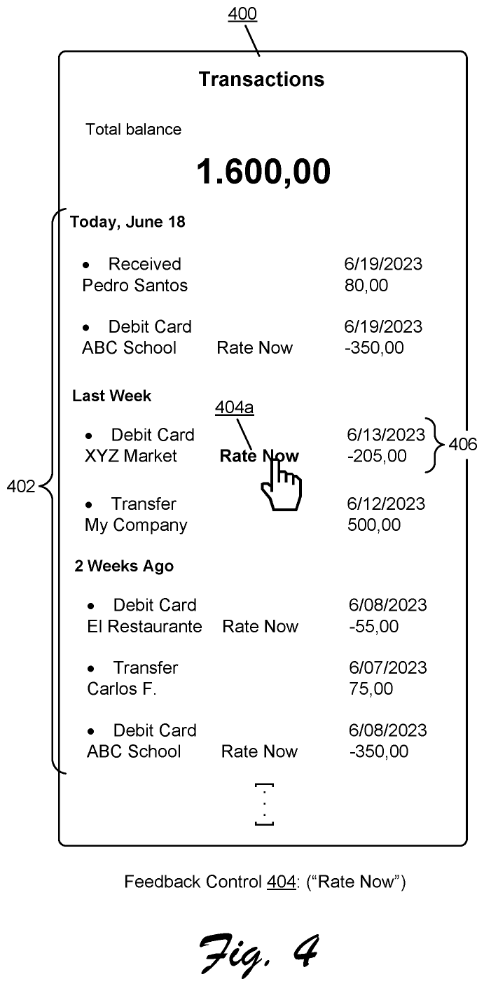

FIG. 4 depicts an example transaction GUI 400 in accordance with one or more implementations. The transaction GUI 400, for instance, is presented via the user device 102 and enables a user to view information about different data transactions (e.g., including data transaction 202) and to provide transaction feedback regarding the data transactions.

The transaction GUI 400 includes a transactions region 402 that identifies different data transactions, such as data transactions that have occurred over a period of time. Each of the data transactions identified in the transactions region 402 includes information about a respective data transaction, such as a data transaction source, a recipient, a date, a data transaction amount, etc.

At least some of the data transactions identified in the transactions region 402 include a respective feedback control 404 that is selectable to enable transaction feedback to be provided regarding a respective data transaction. In this particular example the user 110 selects a feedback control 404a to enable the user 110 to provide transaction feedback regarding a data transaction 406. In at least one implementation the data transaction 406 represents the data transaction 202.

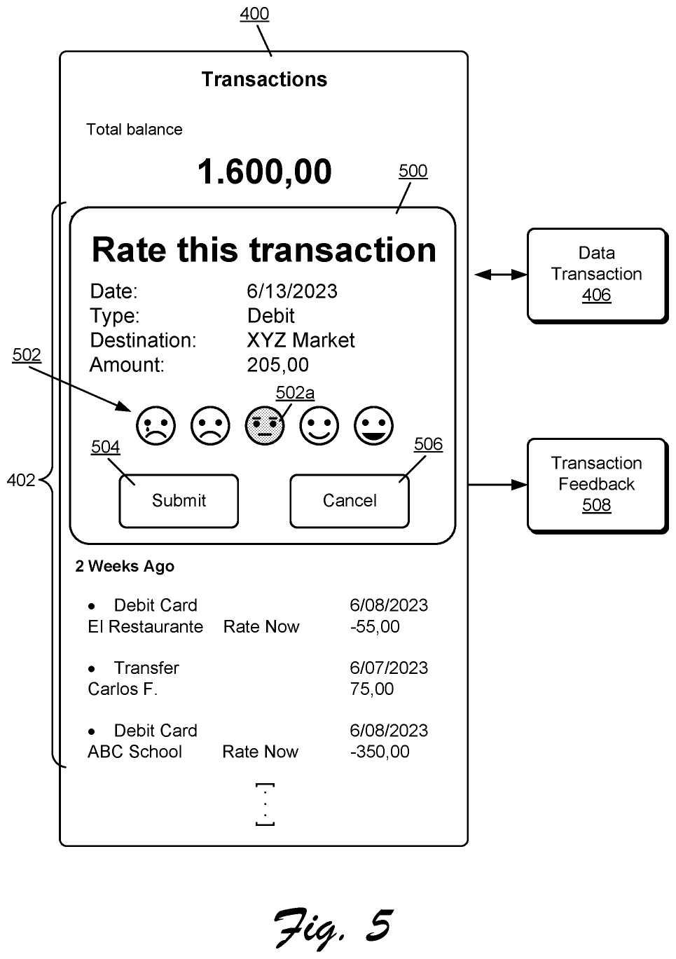

FIG. 5 depicts the example transaction GUI 400 in accordance with one or more implementations. In this particular example, and in response to selection of the feedback control 404a such as described above in the transaction GUI 400, a feedback GUI 500 is output that includes information about the data transaction 406, feedback indicia 502, a submit control 504, and a cancel control 506. The feedback indicia 502 includes different feedback indicia that are selectable to provide transaction feedback 508 regarding the data transaction 406. For instance, each of the feedback indicia 502 represents a respective feedback value, e.g., based on a defined feedback value scale. In at least one implementation feedback values correspond to a different indications of user sentiment regarding the data transaction 406. In this particular example the user 110 selects a feedback indicia 502a, which represents a medium feedback value (e.g., medium user sentiment) regarding the data transaction 406.

The submit control 504 is selectable to cause transaction feedback input to the transaction feedback GUI 500 to be submitted (e.g., to the transaction feedback service 108) and the cancel control 506 is selectable to cause the transaction feedback GUI 500 to be removed, e.g., canceled. For instance, the user 110 selects the feedback indicia 502a and the submit control 504, which can cause transaction feedback 508 (e.g., the initial transaction feedback 210 and/or the subsequent transaction feedback 212) to be communicated to the transaction feedback service 108 and associated with the data transaction 406. The transaction feedback 508, for instance, includes a feedback value represented by the feedback indicia 502a.

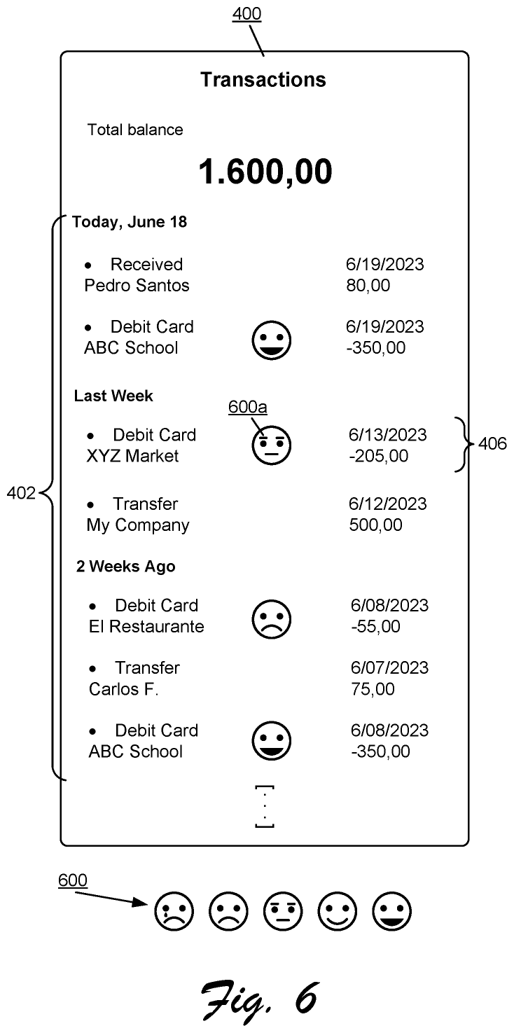

FIG. 6 depicts the example transaction GUI 400 in accordance with one or more implementations. The transaction GUI 400 presented in FIG. 6, for instance, represents a summary view of data transactions and transaction feedback regarding the data transactions. As discussed above, the transaction GUI 400 can be presented via the user device 102 and enables a user to view information about different data transactions, e.g., the data transaction 202 and/or the data transaction 406. In this particular example the transactions region 402 includes different feedback indicia 600 for some data transactions identified in the transactions region 402. The feedback indicia 600, for instance, identify different user feedback provided for different data transactions identified in the transactions region 402. Different ways for determining and generating the feedback indicia 600 are described throughout this disclosure.

For instance, for the data transaction 406, the transactions region 402 includes a feedback indicia 600a that identifies transaction feedback provided for the data transaction 406, such as described above with reference to FIGS. 4, 5. The feedback indicia 600a, for example, is presented based at least in part on user selection of the feedback indicia 502a as described above with reference to FIG. 5.

In at least one implementation the feedback indicia 600 are selectable to modify transaction feedback previously provided for respective data transactions. For instance, the feedback indicia 600a is selectable to cause the feedback GUI 500 to be presented via which the user 110 can select a different feedback indicia 502 to update transaction feedback regarding the data transaction 406. The updated transaction feedback can be communicated to the transaction feedback service 108 and utilized to generate an updated transaction GUI 400 which reflects the updated transaction feedback for the data transaction 406.

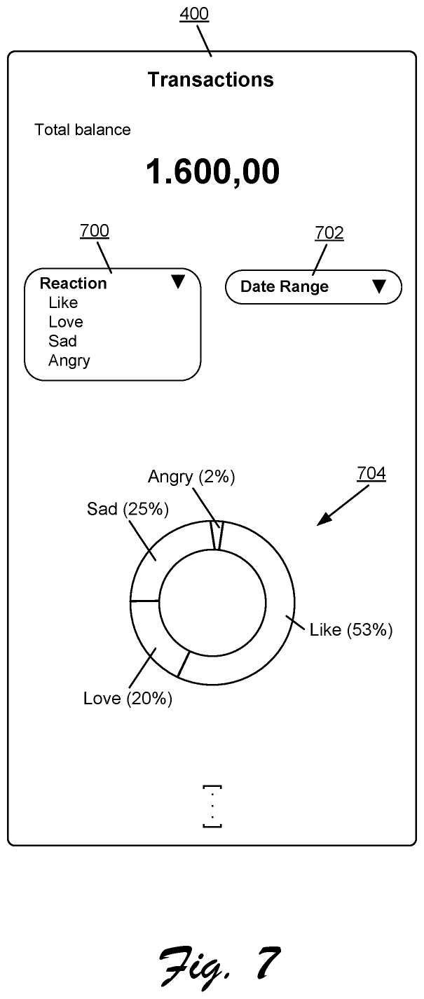

FIG. 7 depicts the example transaction GUI 400 in accordance with one or more implementations. As discussed above, the transaction GUI 400 can be presented via the user device 102 and enables a user to view information about different data transactions. In this particular implementation the transaction GUI 400 includes a reaction menu 700, a date menu 702, and a reaction chart 704. The reaction menu 700 is configured to receive user input to select different instances of transaction feedback types to enable data transactions corresponding to selected transaction feedback types to be presented, e.g., within the transaction GUI 400. For instance, in response to selection of a particular transaction reaction from the reaction menu 700, data transactions with transaction feedback that corresponds to the selected transaction reaction can be presented within the transaction GUI 400.

The date menu 702 is configured to receive user input to select particular dates and/or date ranges for filtering data transaction information presented within the transaction GUI 400. For instance, the user 110 can interact with the date menu 702 to select a date parameter, and transaction feedback for data transactions corresponding to the selected date parameter can be presented within the transaction GUI 400. Further, selected transaction feedback types from the reaction menu 700 can be filtered based on date parameters selected from the date menu 702, and vice versa.

The reaction chart 704 illustrates a relative amount of data transactions that have particular transaction feedback values. In implementations the reaction chart 704 can be generated based on date values selected from the date menu 702. Further, individual sections of the reaction chart 704 can be selectable to present details concerning particular transaction feedback values. For instance, selection of the “Like” section of the reaction chart 704 can cause details concerning data transactions with “Like” values to be presented within the transaction GUI 400.

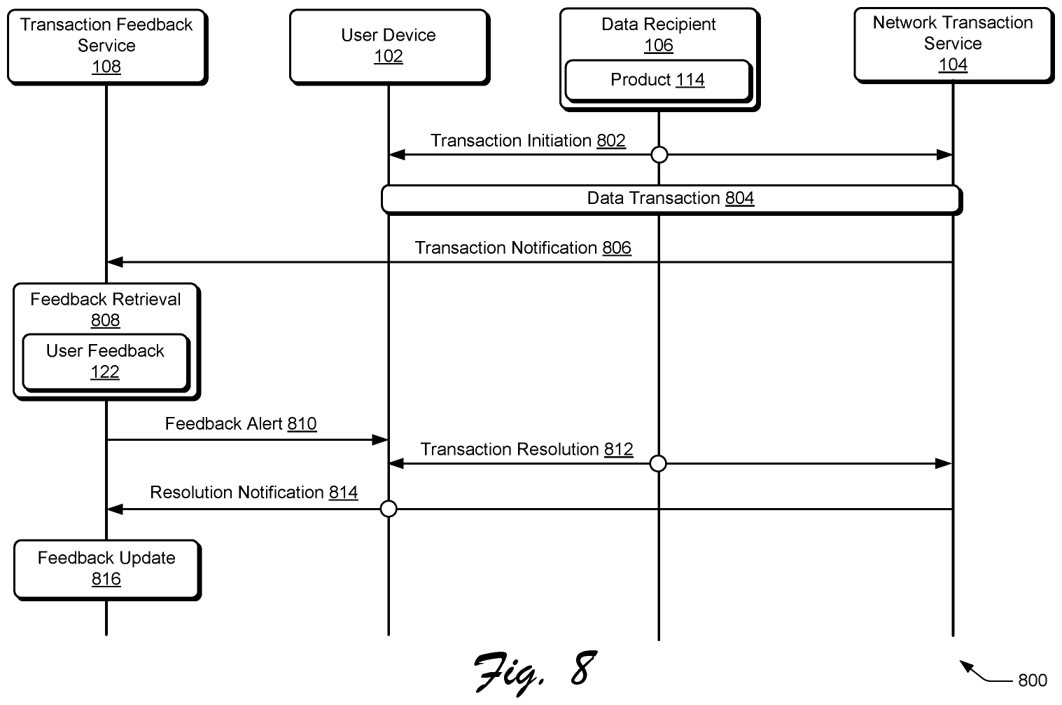

FIG. 8 depict aspects of an example system 800 for feedback for data transactions in accordance with one or more implementations. The system 800 can be implemented in the environment 100 and incorporates attributes of the environment 100 introduced above. Further, the system 800 may be implemented in conjunction with the system 200 described above. For instance, transaction feedback utilized in the system 800 may be generated and/or modified via the system 200.

In the system 800 a transaction initiation 802 is performed to initiate a data transaction 804 between the user device 102 and a data recipient 106. The user 110, for instance, initiates the data transaction 804 to purchase a product 114 from the data recipient 106. Further, the network transaction service 104 is involved in the transaction initiation 802, such as to facilitate payment to the data recipient 106 as part of the data transaction 804. In conjunction with the transaction initiation 802, the network transaction service 104 communicates a transaction notification 806 to the transaction feedback service 108. The transaction notification 806 can include various information about the data transaction 804, such as identity of the user device 102 and/or the user 110, an identity of the data recipient 106, an identity of the product 114, a location of the data recipient 106, etc. The location of the data recipient 106 can be described in various ways, such as a physical location (e.g., geographical location, street address, etc.) and/or a network location such as a website name, web address, IP address, etc.

Further to the system 800 the transaction feedback service 108 utilizes information from the transaction notification 806 to perform feedback retrieval 808 to retrieve an instance of user feedback 122 that is relevant to the data transaction 804. The user feedback 122, for instance, is based on historic user feedback provided by the user 110 regarding the data recipient 106 and/or the product 114. As detailed throughout this disclosure, the user feedback 122 can indicate data that describes user reactions (e.g., ratings, sentiment values, etc.) regarding different data transactions. The user feedback 122, for instance, can indicate whether the user 110 had previously indicated positive or negative feedback regarding the data recipient 106 and/or the product 114.

Accordingly, based at least in part on the user feedback 122, the transaction feedback service 108 generates a feedback alert 810 and communicates the feedback alert 810 to the user device 102. The feedback alert 810, for instance, includes information describing the user feedback 122, such as identifying and/or summarizing historical user feedback regarding the data recipient 106 and/or the product 114. In at least one implementation the feedback alert 810 indicates that the user 110 previously provided negative feedback regarding the data recipient 106 and/or the product 114. The feedback alert 810, for instance, can by output via the user device 102 and can indicate previous negative data transactions regarding the data recipient 106 and/or the product 114.

In another example implementation the feedback alert 810 indicates that the user 110 previously provided positive feedback regarding the data recipient 106 and/or the product 114. The feedback alert 810, for instance, can by output via the user device 102 and can indicate previous positive data transactions regarding the data recipient 106 and/or the product 114.

Continuing, transaction resolution 812 occurs that resolves the data transaction 804. For instance, if the feedback alert 810 indicates previous negative user feedback regarding the data recipient 106 and/or the product 114, as part of the transaction resolution 812 the user 110 can terminate (e.g., cancel) the data transaction 804 prior to completion of the data transaction 804. In another example, the transaction resolution 812 may involve successful completion of the data transaction 804, such as when the feedback alert 810 indicates previous positive user feedback regarding the data recipient 106 and/or the product 114.

Based at least in part on the transaction resolution 812 the network transaction service 104 and/or the user device 102 communicates a resolution notification 814 to the transaction feedback service 108. The resolution notification 814, for instance, indicates a result of the transaction resolution 812, such as whether the data transaction was successfully completed, was terminated prior to completion, etc. Accordingly, the transaction feedback service 108 can perform a feedback update 816 to update user feedback 122 based at least in part on the resolution notification 814. The feedback update 816, for example, can update the user feedback 122 to indicate whether the user 110 proceeded with the data transaction 804 to successfully complete the data transaction 804 or whether the user 110 terminated the data transaction 804 prior to successful completion.

In at least one implementation the system 800 can be combined with the system 200 described above to provide enhanced feedback techniques. For instance, in addition to providing the feedback alert 810, the transaction feedback service 108 can provide the feedback GUI 300 to enable the user 110 to provide feedback regarding the data transaction 804, the data recipient 106, and/or the product 114.

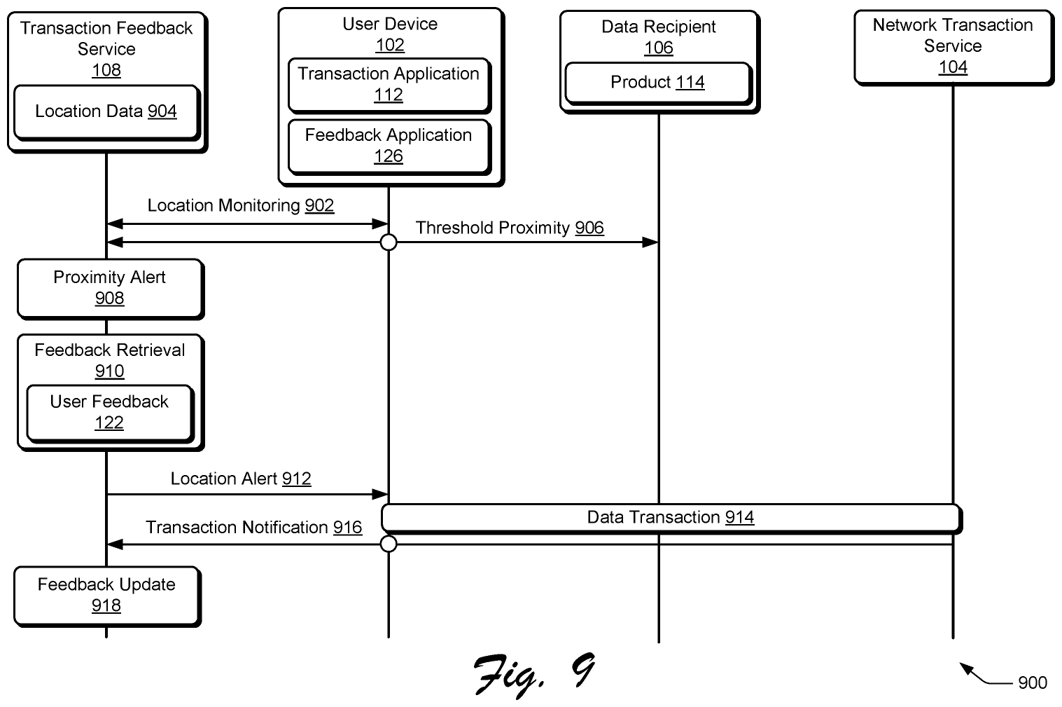

FIG. 9 depict aspects of an example system 900 for alerts for data transactions in accordance with one or more implementations. The system 900 can be implemented in the environment 100 and incorporates attributes of the environment 100 introduced above. Further, the system 900 may be implemented in conjunction with the systems 200, 800 described above.

In the system 900 location monitoring 902 is performed that monitors a location of the user device 102, such as a geographical location, an enterprise-based (e.g., business) location, etc. The location monitoring 902 can be performed in various ways, such by the user device 102 (e.g., via the transaction application 112, the feedback application 126, etc.), by the transaction feedback service 108 (e.g., via location data retrieved for the user device 102), and/or cooperatively between the user device 102 and the transaction feedback service 108.

As part of the location monitoring 902 the transaction feedback service 108 compares a location of the user device 102 to location data 904. The location data 904, for instance, includes identities for different data recipients 106 for which transaction feedback has been provided and locations of the data recipients 106. Based on the location monitoring 902 the transaction feedback service 108 detects that the user device 102 is within a threshold proximity 906 to a data recipient 106 identified in the location data 904. Thus, a proximity alert 908 is generated which indicates that the user device 102 is within the threshold proximity 906 to a location identified in the location data 904, e.g., the data recipient 106. In response to the feedback alert 908 the transaction feedback service 108 performs feedback retrieval 910 to retrieve user feedback 122 associated with the data recipient 106 and/or a product 114 associated with the data recipient 106.

Continuing, the transaction feedback service 108 generates a location alert 912 based on the user feedback 122 and communicates the location alert 912 to the user device 102. The location alert 912, for example, identifies previous transaction feedback provided by the user 110 regarding the data recipient 106 and/or the product 114, such as positive user feedback or negative user feedback. For instance, where the user 110 provided negative feedback for one or more previous data transactions at the data recipient 106, the location alert 912 can identify the negative feedback and/or that the user indicated a previous negative experience at the location of the data recipient 106. In implementations, the location alert 912 can be communicated to the user device 102 when the user device 102 is within the threshold proximity 906 and prior to the user 110 initiating a subsequent data transaction with the data recipient 106.

In an optional implementation of the system 900, the user 110 may proceed with a data transaction 914 with the data recipient 106 (e.g., a purchase of the product 114) after receiving the location alert 912. Thus, the network transaction service 104 can communicate a transaction notification 916 to the transaction feedback service 108 identifying the data transaction 914 and the transaction feedback service 108 can perform a feedback update 918 to update the user feedback 122 and/or the location data 904 based on the data transaction 914.

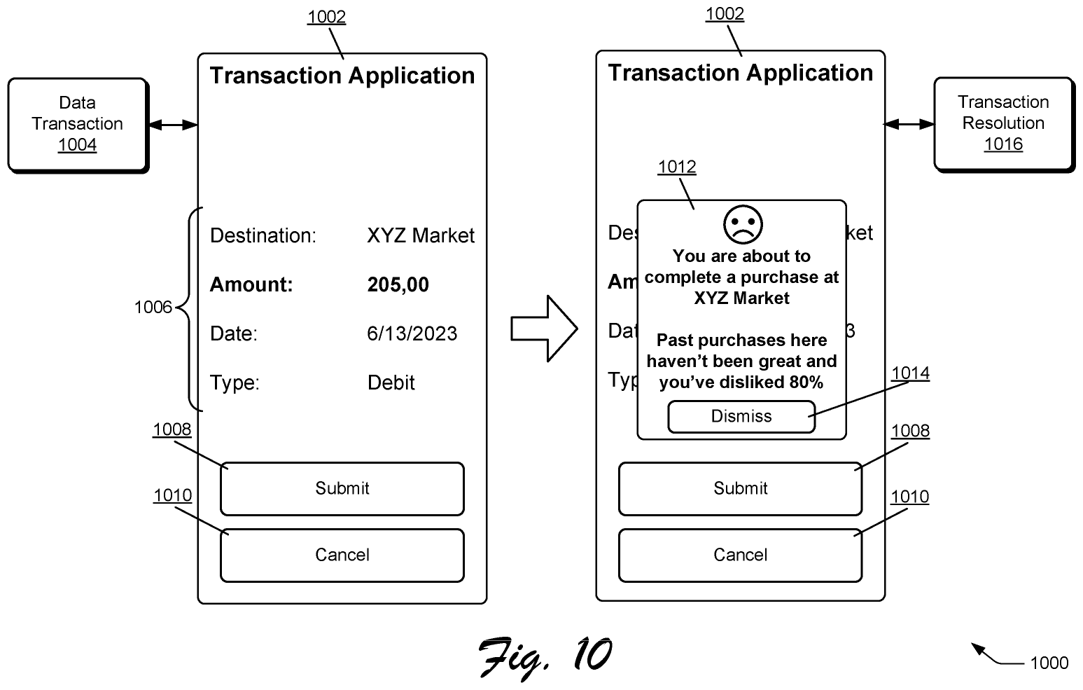

FIG. 10 depicts an example scenario 1000 for alerts for data transactions in accordance with one or more implementations. The scenario 1000, for instance, can be implemented in conjunction with the system 800. The scenario 1000 includes a transaction GUI 1002 such as presented by the network transaction service 104 via the transaction application 112 on the user device 102. In this particular example the user 110 initiates a data transaction 1004 and thus information about the data transaction 1004 is populated to a transaction region 1006. The transaction region 1006, for instance, includes information about the data transaction 1004, such as a destination name for the data transaction 1004 (e.g., a data recipient 106), a value amount, a date, and a transaction type. The transaction GUI 1002 further includes a submit control 1008 that is selectable to cause the data transaction 1004 to be completed and a cancel control 1010 that is selectable to terminate the data transaction 1004 prior to completion.

Further to the scenario 1000 the transaction feedback service 108 detects the pending data transaction 1004 and data about the data transaction 1004, such as described above. The transaction feedback service 108, for instance, determines that the user 110 is about to complete the data transaction 1004 with the “XYZ Market” (e.g., a data recipient 106) and that the user 110 has previously provided negative transaction feedback regarding data transactions with the XYZ Market. Accordingly, the transaction feedback service 108 transmits a feedback alert 1012 to the user device 102 and the user device 102 outputs the feedback alert 1012. The feedback alert 1012 identifies past user feedback regarding data transactions with the XYZ Market, e.g., that the user 110 previously provided negative feedback regarding the majority of data transactions with the XYZ Market. The feedback alert 1012 also includes a dismiss control 1014 that is selectable to remove the feedback alert 1012 from display.

Accordingly, the user 110 can select the submit control 1008 to continue with the data transaction 1004 or the cancel control 1010 to cancel the data transaction 1004. Selection of the submit control 1008 or the cancel control 1010, for instance, causes transaction resolution 1016, e.g., completion or termination of the data transaction 1004.

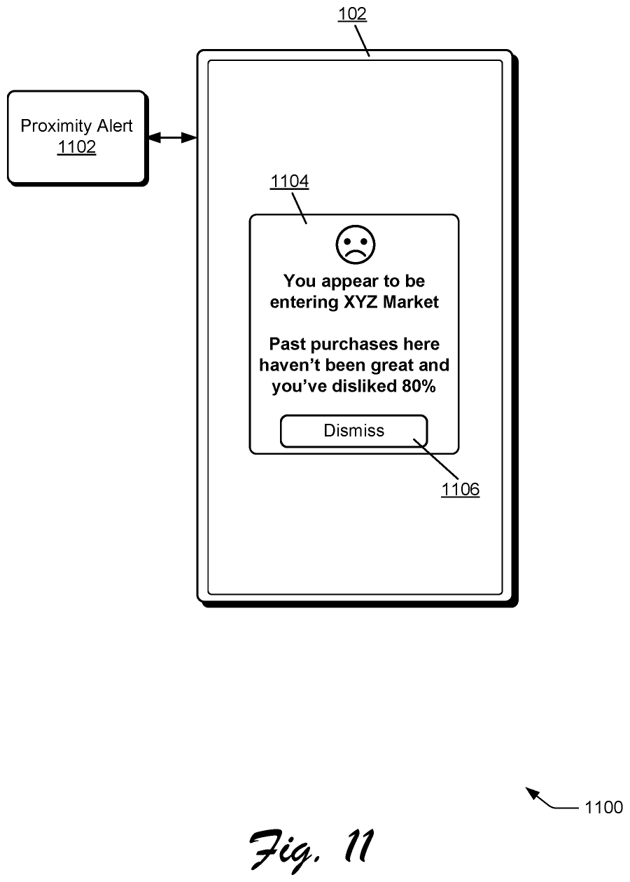

FIG. 11 depicts an example scenario 1100 for location alerts in accordance with one or more implementations. The scenario 1100, for instance, can be implemented in conjunction with the system 900. In the scenario 1100 a proximity alert 1102 is triggered based on a location of the user device 102. The user device 102, for instance, is detected by the transaction feedback service 108 as being within a threshold proximity to a location identified in the location data 904 as being associated with user feedback 122. Accordingly, the transaction feedback service 108 generates a location alert 1104 and communicates the location alert 1104 to the user device 102. The user device 102 can then output the location alert 1104 to notify the user 110 of previous user feedback regarding a detected location. For instance, the user device 102 is detected within a threshold proximity to the XYZ Market and the user 110 has previously provided negative feedback regarding data transactions that occurred at the XYZ Market. Accordingly, the location alert 1104 identifies the past negative transaction feedback.

The location alert 1104 may be output in various ways such as depending on notification permissions of the transaction application 112 and/or notification settings of the user device 102. For instance, the location alert 1104 may be output over a lock screen of the user device 102, over a home screen, over other active applications, in response to the user opening the transaction application 112, etc. Further, the user 110 may select a dismiss control 1106 to dismiss the location alert 1104.

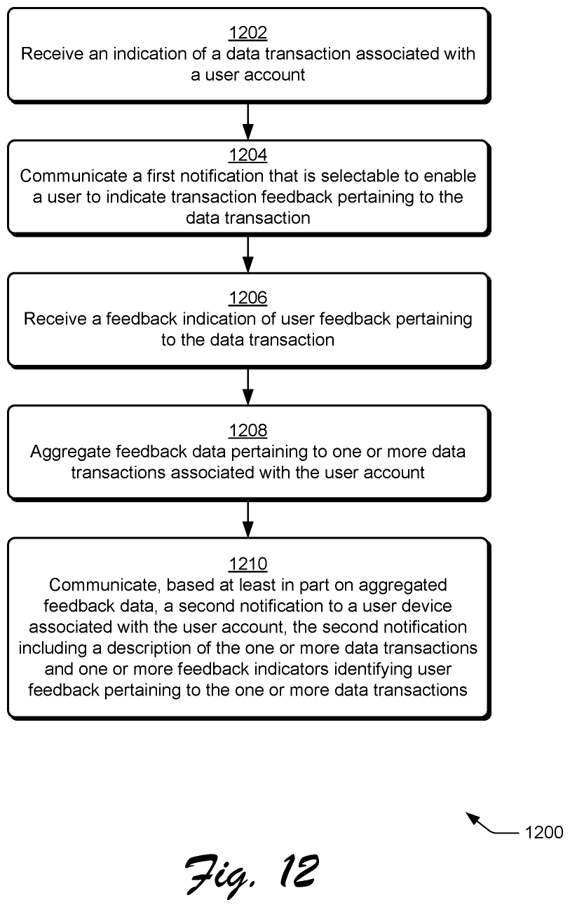

FIG. 12 illustrates a flow chart depicting an example method 1200 for feedback for data transactions in accordance with one or more implementations. Operations of the method 1200, for instance, may be performed in the context of the environment 100, such as by the transaction feedback service 108.

At 1202 an indication is received of a data transaction associated with a user account. The transaction feedback service 108, for instance, receives information indicating that a data transaction between the user device 102 and a data recipient 106 is pending and/or completed. The information regarding the data transaction can be received from the user device 102 and/or the network transaction service 104.

At 1204 a first notification is communicated that is selectable to enable a user to indicate transaction feedback pertaining to the data transaction. The first notification, for instance, identifies a data transaction and includes selectable indicia for providing feedback regarding the data transaction. An example of the first notification is described above with reference to the first notification 208.

At 1206 a feedback indication of user feedback pertaining to the data transaction is received. The user 110, for instance, provides transaction feedback via the user device 102 and the user device 102 communicates the transaction feedback to the transaction feedback service 108. At 1208 feedback data pertaining to one or more data transactions associated with the user account is aggregated. The transaction feedback service 108, for instance, aggregates transaction feedback for different user accounts 116, data transactions, and data recipients 106.

At 1210 and based at least in part on aggregated feedback data, a second notification is communicated to a user device associated with the user account, the second notification including a description of the one or more data transactions and one or more feedback indicators identifying user feedback pertaining to the one or more data transactions. The transaction feedback service 108, for instance, communicates the second notification to the user device 102 enabling the user device to output transaction feedback and other transaction information regarding data transactions. An example of the second notification is described above with reference to the second notification 216.

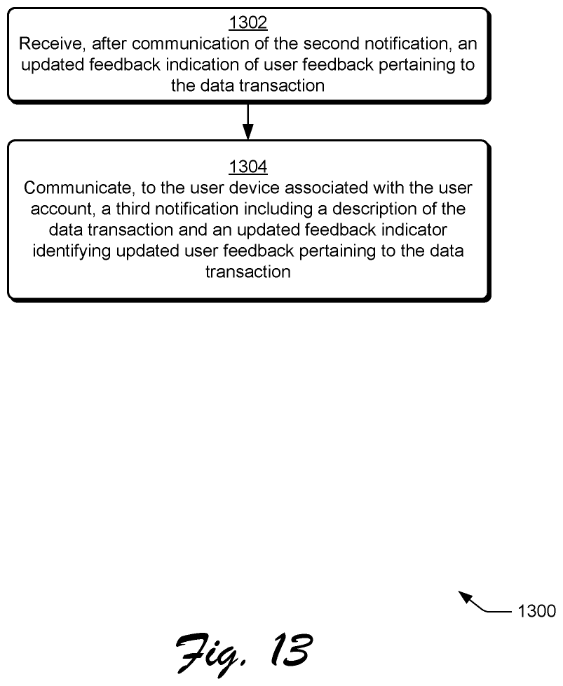

FIG. 13 illustrates a flow chart depicting an example method 1300 for enabling updated transaction feedback in accordance with one or more implementations. Operations of the method 1300, for instance, may be performed in the context of the environment 100, such as by the transaction feedback service 108. Further, the method 1300 may be performed in conjunction with the method 1200.

At 1302 and after communication of the second notification, an updated feedback indication of user feedback pertaining to the data transaction is received. The user 110, for instance, interacts with a transaction GUI and/or a transaction feedback GUI to update previously provided transaction feedback regarding a data transaction. The updated feedback can be communicated from the user device 102 to the transaction feedback service 108.

At 1304 a third notification including a description of the data transaction and an updated feedback indicator identifying updated user feedback pertaining to the data transaction is communicated to the user device associated with the user account. The transaction feedback service 108, for instance, communicates an updated transaction GUI to the user device 102 that includes an updated feedback indicator for the data transaction.

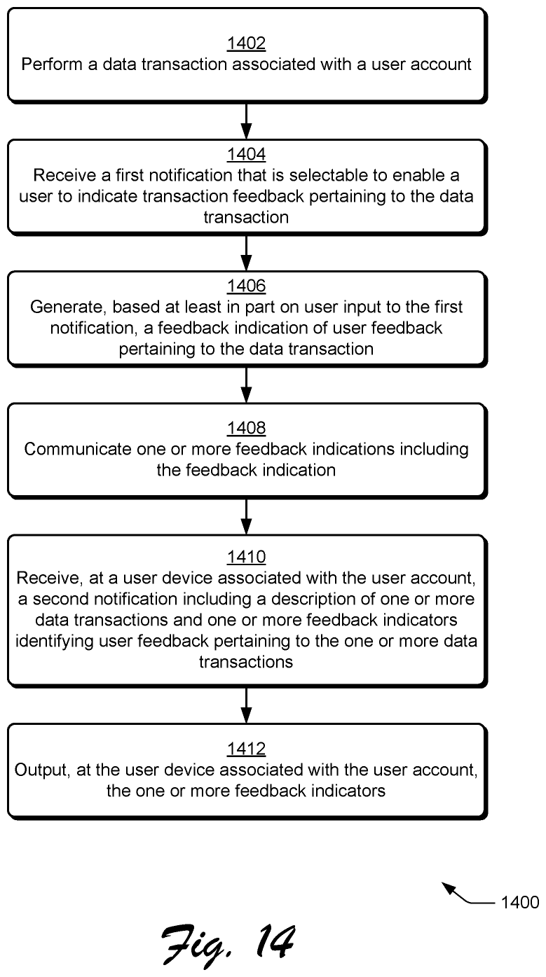

FIG. 14 illustrates a flow chart depicting an example method 1400 for feedback for data transactions in accordance with one or more implementations. Operations of the method 1400, for instance, may be performed in the context of the environment 100, such as by the user device 102 and/or the feedback application 126.

At 1402 a data transaction associated with a user account is performed. The user 110, for instance, interacts with the user device 102 to perform a data transaction with a data recipient 106, such as via the network transaction service 104. At 1404 a first notification is received that is selectable to enable a user to indicate transaction feedback pertaining to the data transaction. The first notification, for instance, identifies attributes of the data transaction and includes selectable indicia that are selectable to indicate user feedback regarding the data transaction. The first notification can be received at various times pertaining to the data transaction, such as within a threshold time period of conclusion of the data transaction, after the threshold time period after conclusion of the data transaction, etc.

At 1406 and based at least in part on user input to the first notification, a feedback indication of user feedback pertaining to the data transaction is generated. For instance, a feedback GUI is presented based at least in part on the first notification, and the user 110 provides transaction feedback to the feedback GUI. The feedback application 126 can generate feedback data for the data transaction describing the user feedback.

At 1408 one or more feedback indications including the feedback indication are communicated. The feedback application 126, for instance, communicates user feedback for different data transactions to the transaction feedback service 108. At 1410 and at a user device associated with the user account, a second notification is received including a description of one or more data transactions and one or more feedback indicators identifying user feedback pertaining to the one or more data transactions. At 1412 and at the user device associated with the user account, the one or more feedback indicators are output. The user device 102, for instance, outputs a transaction GUI including one or more feedback indicators for one or more data transactions, such as the transaction GUI 400.

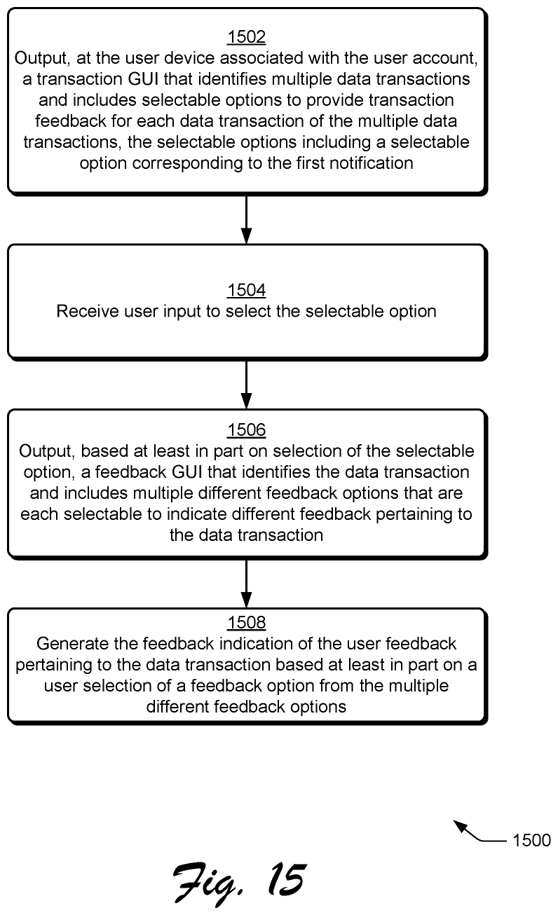

FIG. 15 illustrates a flow chart depicting an example method 1500 for feedback for data transactions in accordance with one or more implementations. Operations of the method 1500, for instance, may be performed in the context of the environment 100, such as by the user device 102 and/or the feedback application 126. In at least one implementation the method 1500 may be implemented in conjunction with the method 1400.

At 1502 and at the user device associated with the user account, a transaction GUI is output that identifies multiple data transactions and includes selectable options to provide transaction feedback for each data transaction of the multiple data transactions, the selectable options including a selectable option corresponding to the first notification. Examples of the transaction GUI are described above and depicted the accompanying figures.

At 1504 receive user input to select the selectable option. The user 110, for instance, interacts with a transaction GUI to select a feedback indicator to provide transaction feedback for a data transaction. At 1506 and based at least in part on selection of the selectable option, a feedback GUI is output that identifies the data transaction and includes multiple different feedback options that are each selectable to indicate different feedback pertaining to the data transaction. Different examples of feedback GUIs are described above and depicted the accompanying figures.

At 1508 the feedback indication of the user feedback pertaining to the data transaction is generated based at least in part on a user selection of a feedback option from the multiple different feedback options. The feedback indication, for instance, is generated by the feedback application 126 and communicated to the transaction feedback service 108.

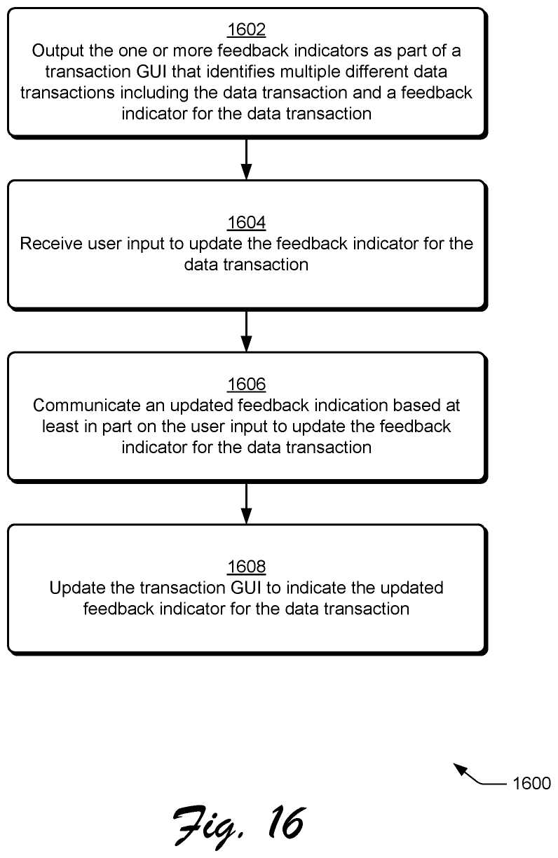

FIG. 16 illustrates a flow chart depicting an example method 1600 for feedback for data transactions in accordance with one or more implementations. Operations of the method 1600, for instance, may be performed in the context of the environment 100, such as by the user device 102 and/or the feedback application 126. In at least one implementation the method 1600 may be implemented in conjunction with the methods 1400, 1500.

At 1602 the one or more feedback indicators are output as part of a feedback GUI that identifies multiple different data transactions including the data transaction and a feedback indicator for the data transaction. The feedback application 126, for instance, outputs a transaction GUI that identifies data transactions and feedback indicia for transaction feedback provided by the user 110 for the data transactions.

At 1604 user input is received to update the feedback indicator for the data transaction. The user 110, for instance, interacts with a transaction GUI and/or a feedback GUI to update previously provided transaction feedback for the data transaction. At 1606 an updated feedback indication is communicated based at least in part on the user input to update the feedback indicator for the data transaction. The user device 102, for instance, communicates the updated feedback indication to the transaction feedback service 108.

At 1608 the transaction GUI is updated to indicate the updated feedback indicator for the data transaction. In at least one implementation the update to the transaction GUI is implemented based on a notification from the transaction feedback service 108.

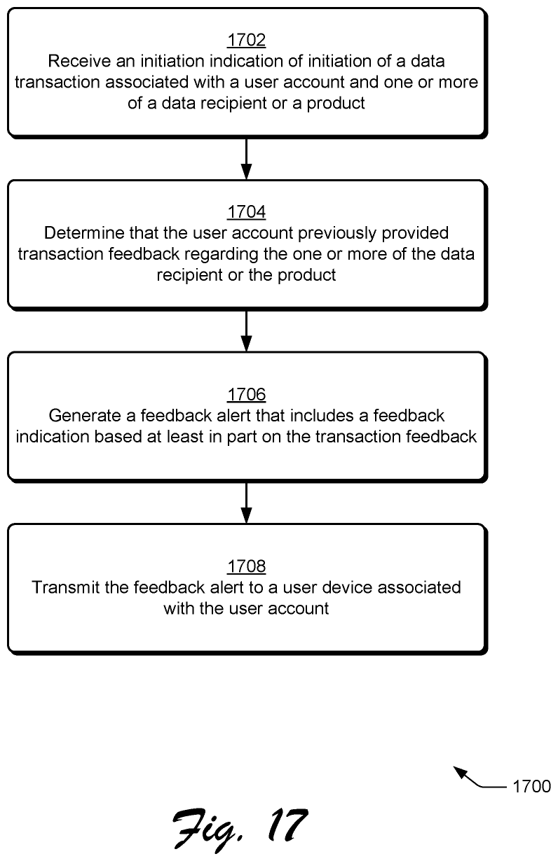

FIG. 17 illustrates a flow chart depicting an example method 1700 for alerts for data transactions in accordance with one or more implementations. Operations of the method 1700, for instance, may be performed in the context of the environment 100, such as by the transaction feedback service 108.

At 1702 an initiation indication is received of initiation of a data transaction associated with a user account and one or more of a data recipient or a product. The transaction feedback service 108, for instance, receives an indication that the user device 102 initiates a data transaction involves a data recipient 106 and/or a product 114.

At 1704 it is determined that the user account previously provided transaction feedback regarding the one or more of the data recipient or the product. The transaction feedback service 108, for instance, searches user feedback data and determines that the user account previously provided user feedback 122 associated with the data recipient 106 and/or the product 114.

At 1706 a feedback alert is generated that includes a feedback indication based at least in part on the transaction feedback. The feedback alert, for instance, includes transaction feedback associated with the previous user feedback associated with the data recipient and/or the product 114.

At 1708 the feedback alert is transmitted to a user device associated with the user account. The transaction feedback service 108, for instance, transmits the feedback alert to a user device 102 associated with the user account.

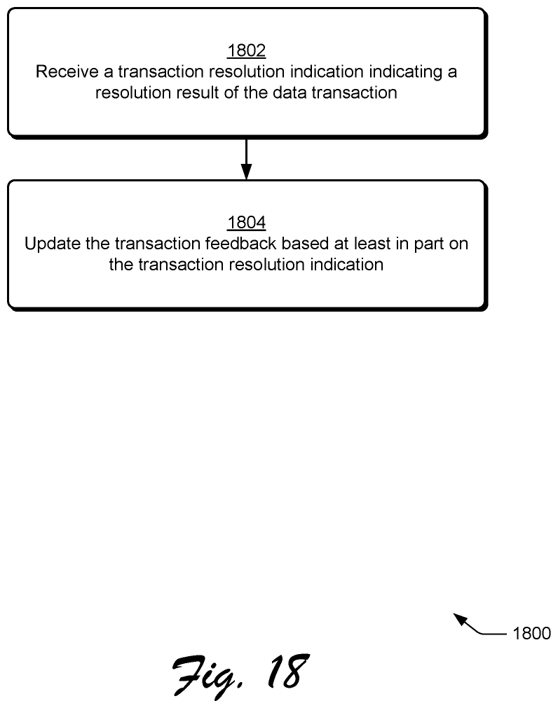

FIG. 18 illustrates a flow chart depicting an example method 1800 for alerts for data transactions in accordance with one or more implementations. Operations of the method 1800, for instance, may be performed in the context of the environment 100, such as by the transaction feedback service 108.

At 1802 a transaction resolution indication is received indicating a resolution result of the data transaction. The transaction feedback service 108, for instance, receives an indication of a resolution result of a data transaction for which a feedback alert and/or a location alert was previously provided.

At 1804 the transaction feedback is updated based at least in part on the transaction resolution indication. The transaction feedback service 108, for instance, updates the transaction feedback based a resolution result of the data transaction.

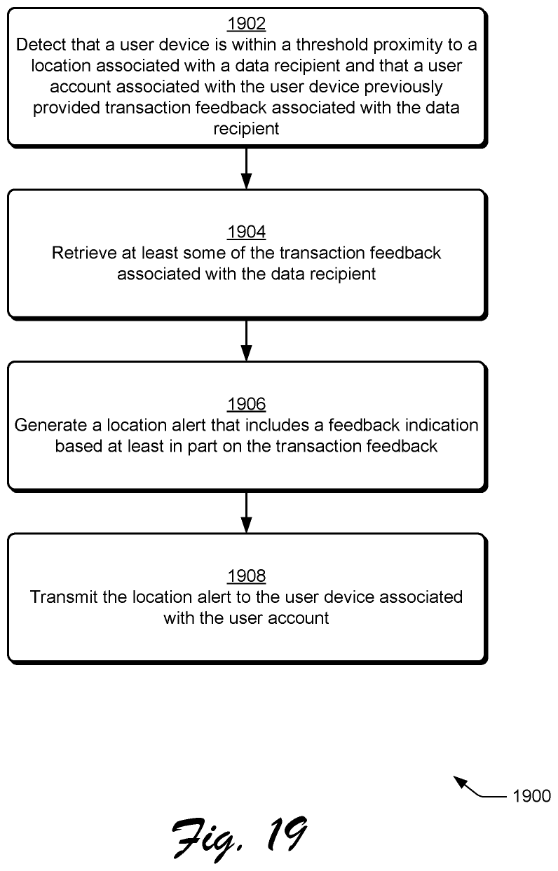

FIG. 19 illustrates a flow chart depicting an example method 1900 for alerts for data transactions in accordance with one or more implementations. Operations of the method 1900, for instance, may be performed in the context of the environment 100, such as by the transaction feedback service 108.

At 1902 it is detected that a user device is within a threshold proximity to a location associated with a data recipient and that a user account associated with the user device previously provided transaction feedback associated with the data recipient. The transaction feedback service 108, for instance, detects that a user device 102 is within a threshold proximity to a data recipient 106 for which transaction feedback was previously provided.

At 1904 at least some of the transaction feedback associated with the data recipient is retrieved. The transaction feedback service 108, for example, retrieves transaction feedback associated with the user account and the location of the data recipient 106.

At 1906 a location alert is generated that includes a feedback indication based at least in part on the transaction feedback. For instance, the transaction feedback service 108 generates the location alert to identify transaction feedback associated with the data recipient 106 at the location.

At 1908 the location alert is transmitted to the user device associated with the user account. The transaction feedback service 108, for examples, transmits the location alert to a user device 102 associated with the user account.

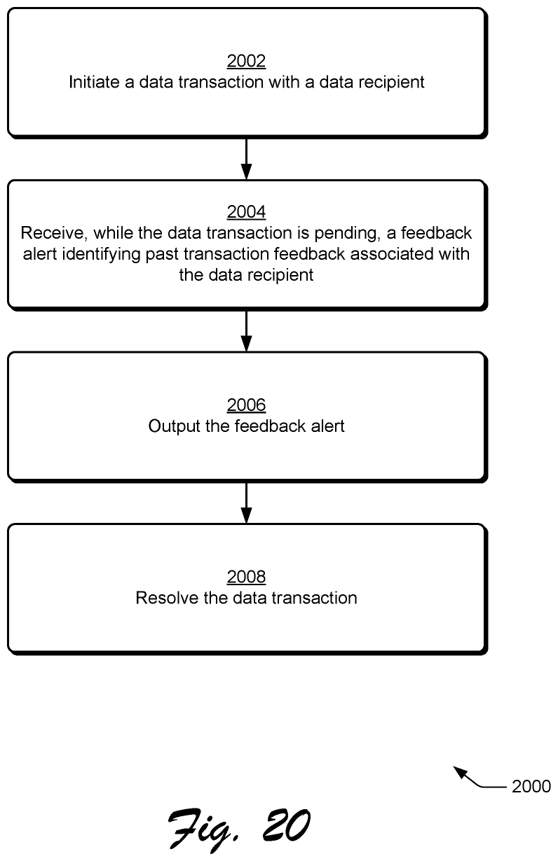

FIG. 20 illustrates a flow chart depicting an example method 2000 for alerts for data transactions in accordance with one or more implementations. Operations of the method 2000, for instance, may be performed in the context of the environment 100, such as by a user device 102.

At 2002 a data transaction is initiated with a data recipient. A user device 102, for instance, utilizes the transaction application 112 to initiate a data transaction (e.g., a purchase of a product) with a data recipient 106. At 2004 while the data transaction is pending, a feedback alert is received identifying past transaction feedback associated with the data recipient. The user device 102, for instance, receives a feedback alert that identifies previously provided transaction feedback associated with the data recipient 106.

At 2006 the feedback alert is output. For instance, the user device 102 displays the feedback alert, and other types of alert output can be provided such as audible output and/or tactile output. At 2008 the data transaction is resolved. The user 110, for instance, either terminates the data transaction prior to completion or proceeds to successful completion of the data transaction.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 21 illustrates various components of an example device 2100 in which aspects of alerts for data transactions can be implemented. The example device 2100 can be implemented as any of the devices described with reference to the previous FIGS. 1-20, such as any type of mobile device, mobile phone, mobile device, wearable device, tablet, computing, communication, entertainment, gaming, media playback, and/or other type of electronic device. For example, the user device 102 and/or the transaction feedback service 108 as shown and described with reference to FIGS. 1-20 may be implemented as the example device 2100.

The device 2100 includes communication transceivers 2102 that enable wired and/or wireless communication of device data 2104 with other devices. The device data 2104 can include any of device identifying data, device location data, wireless connectivity data, and wireless protocol data. Additionally, the device data 2104 can include any type of audio, video, and/or image data. Example communication transceivers 2102 include wireless personal area network (WPAN) radios compliant with various IEEE 2102.15 (Bluetooth™) standards, wireless local area network (WLAN) radios compliant with any of the various IEEE 2102.10 (Wi-Fi™) standards, wireless wide area network (WWAN) radios for cellular phone communication, wireless metropolitan area network (WMAN) radios compliant with various IEEE 2102.16 (WiMAX™) standards, and wired local area network (LAN) Ethernet transceivers for network data communication.

The device 2100 may also include one or more data input ports 2106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 2100 includes a processing system 2108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 2110. The device 2100 may further include any type of a system bus or other data and command transfer system that couples the various components within the device. A system bus can include any one or combination of different bus structures and architectures, as well as control and data lines.

The device 2100 also includes computer-readable storage memory 2112 (e.g., memory devices) that enable data storage, such as data storage devices that can be accessed by a computing device, and that provide persistent storage of data and executable instructions (e.g., software applications, programs, functions, and the like). Examples of the computer-readable storage memory 2112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 2100 may also include a mass storage media device.

The computer-readable storage memory 2112 provides data storage mechanisms to store the device data 2104, other types of information and/or data, and various device applications 2114 (e.g., software applications). For example, an operating system 2116 can be maintained as software instructions with a memory device and executed by the processing system 2108. The device applications may also include a device manager, such as any form of a control application, software application, signal-processing and control module, code that is native to a particular device, a hardware abstraction layer for a particular device, and so on. Computer-readable storage memory 2112 represents media and/or devices that enable persistent and/or non-transitory storage of information in contrast to mere signal transmission, carrier waves, or signals per se. Computer-readable storage memory 2112 do not include signals per se or transitory signals.

In this example, the device 2100 includes a transaction feedback service 2118 that implements aspects of feedback and alerts for data transactions and may be implemented with hardware components and/or in software as one of the device applications 2114. For example, the transaction feedback service 2118 can be implemented via the user device 102 and/or the transaction feedback service 108. In implementations, the transaction feedback service 2118 may include independent processing, memory, and logic components as a computing and/or electronic device integrated with the device 2100. The device 2100 also includes transaction feedback data 2120 for implementing aspects of feedback and alerts for data transactions and may include data from the transaction feedback service 2118, such as data for managing data transaction feedback and feedback alerts.

In this example, the example device 2100 also includes a camera 2122 and motion sensors 2124, such as may be implemented in an inertial measurement unit (IMU). The motion sensors 2124 can be implemented with various sensors, such as a gyroscope, an accelerometer, and/or other types of motion sensors to sense motion of the device. The various motion sensors 2124 may also be implemented as components of an inertial measurement unit in the device.

The device 2100 also includes a wireless module 2126, which is representative of functionality to perform various wireless communication tasks. The device 2100 can also include one or more power sources 2128, such as when the device is implemented as a mobile device. The power sources 2128 may include a charging and/or power system, and can be implemented as a flexible strip battery, a rechargeable battery, a charged super-capacitor, and/or any other type of active or passive power source.

The device 2100 also includes an audio and/or video processing system 2130 that generates audio data for an audio system 2132 and/or generates display data for a display system 2134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 2136. In implementations, the audio system and/or the display system are integrated components of the example device. Alternatively, the audio system and/or the display system are external, peripheral components to the example device.

Although implementations of feedback and alerts for data transactions have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a system including: one or more processors; and computer-readable storage media storing instructions that are executable by the one or more processors to: receive an initiation indication of initiation of a data transaction associated with a user account and one or more of a data recipient or a product; determine that the user account previously provided transaction feedback regarding the one or more of the data recipient or the product; generate a feedback alert that includes a feedback indication based at least in part on the transaction feedback; and transmit the feedback alert to a user device associated with the user account.

In some aspects, the techniques described herein relate to a system, wherein the data transaction includes one or more of a finance transaction or a transaction pertaining to user data.

In some aspects, the techniques described herein relate to a system, wherein the initiation indication includes one or more of an identity of the user device, a user identity associated with the user account, an identity of the data recipient, an identity of the product, or a location of the data recipient.

In some aspects, the techniques described herein relate to a system, wherein the instructions are executable by the one or more processors to transmit the feedback alert while the data transaction is in a pending state.

In some aspects, the techniques described herein relate to a system, wherein the instructions are executable by the one or more processors to generate the feedback alert to indicate a primary feedback value of the transaction feedback.

In some aspects, the techniques described herein relate to a system, wherein the feedback alert includes an identity of the data recipient and a primary feedback value for the data recipient.

In some aspects, the techniques described herein relate to a system, wherein the feedback alert includes an identity of the product and a primary feedback value for the product.

In some aspects, the techniques described herein relate to a system, wherein the instructions are executable by the one or more processors to: receive a transaction resolution indication indicating a resolution result of the data transaction; and update the transaction feedback based at least in part on the transaction resolution indication.

In some aspects, the techniques described herein relate to a system, wherein the transaction resolution indication indicates whether the data transaction was successfully completed or was terminated prior to completion.

In some aspects, the techniques described herein relate to a system, wherein the instructions are executable by the one or more processors to: transmit, after receipt of the transaction resolution indication, a first notification that is selectable to enable a user to indicate transaction feedback pertaining to the data transaction; receive further transaction feedback pertaining to the resolution result of the data transaction; and further update the transaction feedback based at least in part on the further transaction feedback.

In some aspects, the techniques described herein relate to a system including: one or more processors; and computer-readable storage media storing instructions that are executable by the one or more processors to: detect that a user device is within a threshold proximity to a location associated with a data recipient and that a user account associated with the user device previously provided transaction feedback associated with the data recipient; retrieve at least some of the transaction feedback associated with the data recipient; generate a location alert that includes a feedback indication based at least in part on the transaction feedback; and transmit the location alert to the user device associated with the user account.

In some aspects, the techniques described herein relate to a system, wherein to detect that the user device is within the threshold proximity to the location associated with the data recipient, the instructions are executable by the one or more processors to: monitor a location of the user device; and compare the location of the user device to location data that identifies locations for which the user account previously provided transaction feedback.

In some aspects, the techniques described herein relate to a system, wherein the at least some of the transaction feedback associated with the data recipient includes transaction feedback for at least one product associated with the data recipient.

In some aspects, the techniques described herein relate to a system, wherein the instructions are executable by the one or more processors to transmit the location alert to the user device associated with the user account prior to a subsequent data transaction at the location associated with the data recipient.

In some aspects, the techniques described herein relate to a system, wherein the instructions are executable by the one or more processors to: receive a transaction resolution indication indicating a resolution result of a data transaction at the location associated with the data recipient; and update the transaction feedback associated with the data recipient based at least in part on the transaction resolution indication.

In some aspects, the techniques described herein relate to a mobile device including: one or more processors; and computer-readable storage media storing instructions that are executable by the one or more processors to: initiate a data transaction with a data recipient; receive, while the data transaction is pending, a feedback alert identifying past transaction feedback associated with the data recipient; output the feedback alert; and resolve the data transaction.

In some aspects, the techniques described herein relate to a mobile device, wherein the data transaction includes one or more of a finance transaction or a transaction pertaining to user data.

In some aspects, the techniques described herein relate to a mobile device, wherein the instructions are executable by the one or more processors to output the feedback alert as part of a graphical user interface of a transaction application used to initiate the data transaction.

In some aspects, the techniques described herein relate to a mobile device, wherein the feedback alert identifies one or more products associated with the data recipient and the past transaction feedback.

In some aspects, the techniques described herein relate to a mobile device, wherein the instructions are executable by the one or more processors to: receive, after resolution of the data transaction, a first notification that is selectable to enable a user to indicate transaction feedback pertaining to the data transaction; and transmit further transaction feedback pertaining to a resolution result of the data transaction.

1. A system comprising:
one or more processors; and
computer-readable storage media storing instructions that are executable by the one or more processors to:
compare location data for a mobile device to location data for data recipients to determine that a physical location of the mobile device is within a threshold proximity to a physical location of a data recipient;
receive an initiation indication of initiation of a data transaction associated with a user account, the data recipient, and a product associated with the data recipient;
determine that the user account previously provided transaction feedback regarding one or more of the data recipient or the product;
generate a feedback alert that includes a feedback indication based at least in part on the transaction feedback; and
transmit the feedback alert to the mobile device.

2. The system of claim 1, wherein the data transaction comprises one or more of a finance transaction or a transaction pertaining to user data.

3. The system of claim 1, wherein the initiation indication comprises one or more of an identity of the mobile device, a user identity associated with the user account, an identity of the data recipient, an identity of the product, or a location of the data recipient.

4. The system of claim 1, wherein the instructions are executable by the one or more processors to transmit the feedback alert while the data transaction is in a pending state.

5. The system of claim 1, wherein the instructions are executable by the one or more processors to generate the feedback alert to indicate a primary feedback value of the transaction feedback.

6. The system of claim 1, wherein the feedback alert comprises an identity of the data recipient and a primary feedback value for the data recipient.

7. The system of claim 1, wherein the feedback alert comprises an identity of the product and a primary feedback value for the product.

8. The system of claim 1, wherein the instructions are executable by the one or more processors to:
receive a transaction resolution indication indicating a resolution result of the data transaction; and
update the transaction feedback based at least in part on the transaction resolution indication.

9. The system of claim 8, wherein the transaction resolution indication indicates whether the data transaction was successfully completed or was terminated prior to completion.

10. The system of claim 9, wherein the instructions are executable by the one or more processors to:
transmit, after receipt of the transaction resolution indication, a first notification that is selectable to enable a user to indicate transaction feedback pertaining to the data transaction;
receive further transaction feedback pertaining to the resolution result of the data transaction; and
further update the transaction feedback based at least in part on the further transaction feedback.

11-15. (canceled)

16. A mobile device comprising:
one or more processors; and
computer-readable storage media storing instructions that are executable by the one or more processors to:
transmit location data indicating a physical location of the mobile device;
initiate a data transaction with a data recipient located within a threshold proximity to the physical location of the mobile device;
receive, while the data transaction is pending, a feedback alert identifying past transaction feedback associated with the data recipient;
output the feedback alert; and
resolve the data transaction.

17. The mobile device of claim 16, wherein the data transaction comprises one or more of a finance transaction or a transaction pertaining to user data.

18. The mobile device of claim 16, wherein the instructions are executable by the one or more processors to output the feedback alert as part of a graphical user interface of a transaction application used to initiate the data transaction.

19. The mobile device of claim 16, wherein the feedback alert identifies one or more products associated with the data recipient and the past transaction feedback.

20. The mobile device of claim 16, wherein the instructions are executable by the one or more processors to:
receive, after resolution of the data transaction, a first notification that is selectable to enable a user to indicate transaction feedback pertaining to the data transaction; and
transmit further transaction feedback pertaining to a resolution result of the data transaction.

21. A method comprising:
comparing location data for a mobile device to location data for data recipients to determine that a physical location of the mobile device is within a threshold proximity to a physical location of a data recipient;
receiving an initiation indication of initiation of a data transaction associated with a user account, the data recipient, and a product associated with the data recipient;
determining that the user account previously provided transaction feedback regarding one or more of the data recipient or the product;
generating a feedback alert that includes a feedback indication based at least in part on the transaction feedback; and
transmitting the feedback alert to the mobile device.

22. The method of claim 21, wherein the data transaction comprises one or more of a finance transaction or a transaction pertaining to user data.

23. The method of claim 21, wherein the initiation indication comprises one or more of an identity of the mobile device, a user identity associated with the user account, an identity of the data recipient, an identity of the product, or a location of the data recipient.

24. The method of claim 21, further comprising transmitting the feedback alert while the data transaction is in a pending state.

25. The method of claim 21, further comprising generating the feedback alert to indicate a primary feedback value of the transaction feedback.
